(19) United States
(12) Patent Application Publication
(10) Pub. No.: US 2010/0055399 A1
(43) Pub. Date: Mar. 4, 2010

(54) Distortion Resistant Roofing Material

(75) Inventors: Steven F. Rosko, Ovilla, TX (US); Stephen A. Buzza, Ovilla, TX (US); John B. Wells, Mansfield, TX (US); Troy D. Morales, Ennis, TX (US); Matti Kiik, Richardson, TX (US)

Correspondence Address: FITZPATRICK CELLA HARPER & SCINTO, 1290 Avenue of the Americas, NEW YORK, NY, 10104-3800, US

(73) Assignee: Building Materials Investment Corp., Wilmington, DE (US)

(21) Appl. No.: 12/549,750

(22) Filed: Aug. 28, 2009

Related U.S. Application Data
(60) Provisional application No. 61/092,673, filed on Aug. 28, 2008.

(51) Int. Cl. B32B 5/16; B32B 15/02; B32B 9/00; B32B 19/00

(52) U.S. Cl. 428/148; 428/143; 428/149; 428/150

(57) ABSTRACT

A roofing material, such as laminated shingles, comprising fines deposited on an upper surface of the roofing material, particularly on one or more non-weathering regions, such as on the headlap region, and/or shim layer. The fines may be deposited, for example, as a strip from about 0.5 inches to about 2.5 inches in width and extend the length of the roofing material at a fixed position from one edge of the roofing material to the opposite edge of the roofing material. The fines may comprise mica flakes, copper slag, coal slag, sand, talc, expanded clay, slate flour, powdered limestone or silica dust.

### FIELD OF THE INVENTION

This invention relates to improved roofing materials, and in particular to roofing shingles, that include fines on the upper surface of the roofing material which render the materials more resistant to distortion during transport and storage and from weathering than traditional roofing products such that the materials demonstrate improved storage properties and long-term shingle performance while providing the desired properties of traditional roofing products.

### BACKGROUND OF THE INVENTION

Roofing material has an upper surface intended to be exposed to weather and a lower surface facing in the direction opposite to the upper surface. Traditionally, the lower surface or back of roofing material, such as shingles, has been coated with asphalt material and covered with finely ground mineral material (fines) so that the asphalt backing does not adhere to contiguous roofing material when packaged for transport and storage. Such finely divided materials include mica flakes, copper slag, coal slag, sand, talc, expanded clay, slate flour, powdered limestone and silica dust. The upper surfaces of traditional roofing materials do not include fines.

Traditional roofing materials can become distorted during storage and transport, which can adversely affect their long-term performance. Most roofing shingles are made to last at least 20 years. It is desirable to improve the long-term performance of roofing shingles, which has traditionally been achieved by increasing the thickness of the materials used to make the shingles or by using substrates that are more durable but that also are associated with higher cost. The present invention relates to improved roofing materials having better distortion and long-term performance properties than traditional roofing materials.

### SUMMARY OF THE INVENTION

In accordance with the invention, roofing materials, such as laminated shingles, are improved to make them more resistant to distortion from storage, transport and weathering by providing fines on the upper surfaces of the roofing materials, preferably on the headlap region and/or on the shims, also known as the backer strips, of laminated shingles.

The roofing materials of the present invention may be any traditional roofing material, including roll roofing, tab shingles and laminated shingles, which include at least a region of fines on the upper surface of the roofing material and preferably on a non-weathering region, i.e., the region of the upper surface that is not exposed when it is installed on a roof deck, such as the headlap region, and/or the shim layer of a laminated shingle.

In one embodiment, the fines are deposited on the upper surface as at least one strip of fines that extends along the length of the roofing material at a fixed position from one edge of the roofing material to the opposite edge of the roofing material. In a preferred embodiment, the strip is from about 0.5 inches to about 2.5 inches in width, such as from about 0.75 inches to about 1.5 inches, or about 1 inch. The roofing material may further comprise two or more strips of fines, for example a strip of fines on the shim layer and a strip of fines on the dragon teeth layer of a laminated shingle.

### BRIEF DESCRIPTION OF THE DRAWING

For a better understanding of the present invention, reference is made to the following examples and drawing. Referring to the Drawings:

FIG. 1 shows a schematic representation of the positions of fines across the width of an upper surface of a laminated shingle during production.

FIG. 2 shows a schematic representation of an apparatus for applying the fines on the upper surface of a shingle.

### DETAILED DESCRIPTION

Asphalt roofing materials, including shingles, have traditionally and extensively been manufactured by using as a base a fibrous web, such as a sheet of roofing felt or a fiberglass mat, impregnating the fibrous web with a bituminous material and coating one or both surfaces of the impregnated web with a weather-resistant bituminous coating material. The bituminous coating material usually contains a filler. “Filler” refers to fines that are mixed into the bituminous material prior to coating the fibrous web. “Fines” refer to finely divided materials, including mica flakes, copper slag, coal slag, sand, talc, expanded clay, slate flour, powdered limestone, silica dust or the like. Sometimes one or more fibrous sheets with one or more bituminous layers are laminated. Usually there is applied to the bituminous coating on the upper surface, which is intended to be exposed to the weather, a suitable granular material such as slate granules or mineral surfacing. Fines, on the other hand, are traditionally adhered to the non-weather exposed lower surface of the roofing shingle to prevent sticking of the adjacent layers of the roofing material in packages.

In the present invention, the upper surface of the bituminous coated fibrous web of traditional roofing materials also includes fines deposited on one or more regions of the upper surface. By depositing the fines on the upper surface, roofing materials, such as shingles, surprisingly demonstrate greater distortion resistance during transport and. storage and from weathering. In addition, in the present invention, preferably only a portion of the widthwise dimension of the upper surface includes fines.

In a specific embodiment, the roofing material of the present invention comprises a substrate, asphalt material and roofing granules. The lower surface of the roofing materials may include fines. In addition, the upper surface, which includes roofing granules, also comprises fines in one or more regions of the roofing material. In a preferred embodiment, the fines are provided on the non-weathering surface of the upper surface of a roofing material. In another preferred embodiment, the fines are provided on the headlap of the roofing material. “Headlap” or “headlap region” refers to the region of the roofing material that is covered, or overlapped, by another roofing material and thus, is non-weathering. For example, the headlap region of roll roofing is the region that is overlapped by another sheet of roll roofing when it is installed on a roof deck. Similarly, the headlap region of shingles, such as tab or laminated shingle, is the region of a shingle that is overlapped by another shingle when it is installed on a roof deck.

In a particularly preferred embodiment, the roofing material is a laminated shingle having a dragon teeth layer and a shim, or backer strip, layer adhered under the dragon teeth layer. “Dragon teeth layer,” or “dragon teeth portion” refers to a part of a laminated shingle comprising the headlap and the dragon teeth. “Shim,” “shim layer,” or “backing strip” refers to a part of a laminated shingle comprising a section that is adhered under the dragon teeth of the dragon teeth layer, and includes at least one non-weathering section, and at least one weathering section that is exposed between the dragon teeth. In a most preferred embodiment, the laminated shingle includes a strip of fines approximately one inch wide on the shim layer and on the dragon teeth layer.

The fines may be applied to the upper surface of a roofing material in one or more regions, including the headlap, shim/backer strip and/or dragon teeth portion. In a preferred embodiment, the fines are provided as at least one strip on the upper surface of the roofing material. The strip of fines as applied to the roofing material is preferably from about 0.5 inches to about 2.5 inches in width and extends the length of the roofing material at a fixed position from one edge of the roofing material to the opposite edge of the roofing material. In a more preferred embodiment, the strip of fines is from about 0.75 inches to about 1.5 inches in width. In a particularly preferred embodiment, the strip of fines is approximately 1 inch in width. The width of the strip of fines is adjusted accordingly if fines are deposited on two abutting regions. For example, if two shim regions abut each other, the strip of fines is preferably from about 1 inch to about 2.5 inches.

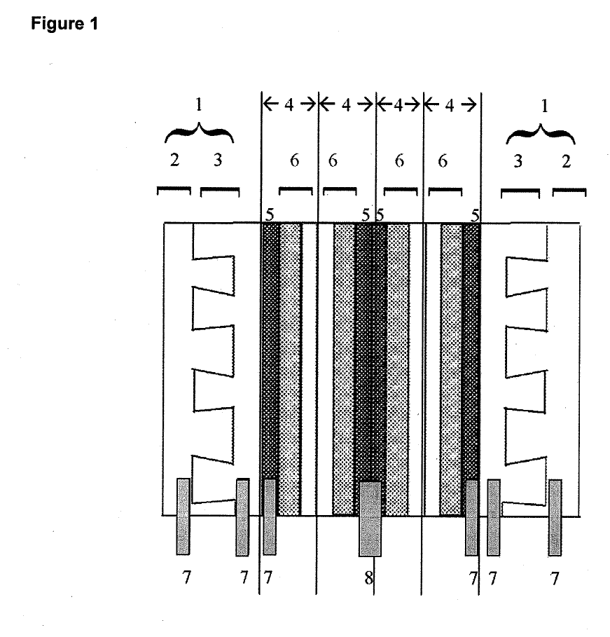

FIG. 1 shows exemplary positioning during the roofing material making process of fines strips across the width of a roofing material according to one embodiment of the present invention. Fines [7 & 8] are deposited on the headlap region [2] of the dragon teeth portion [1] and the non-weathering section [5] of the shim [4], but not the dragon teeth [3] of the dragon teeth portion [1] or the weathering section [6] of the shim [4], of a laminated shingle during production. FIG. 1 also indicates that the fines strips are one width for each region [7], but are wider when deposited on two regions abut each other [8].

In a particularly preferred embodiment the fines strips are designed to be approximately 1 inch in width and extend the length of a roofing material at a fixed position that is equidistant from an edge of the roofing material. In another embodiment, the fines are provided on the headlap region of the dragon teeth layer and the non-weathering section of the shim layer, which are not exposed to weather when the shingles are installed on a roof deck.

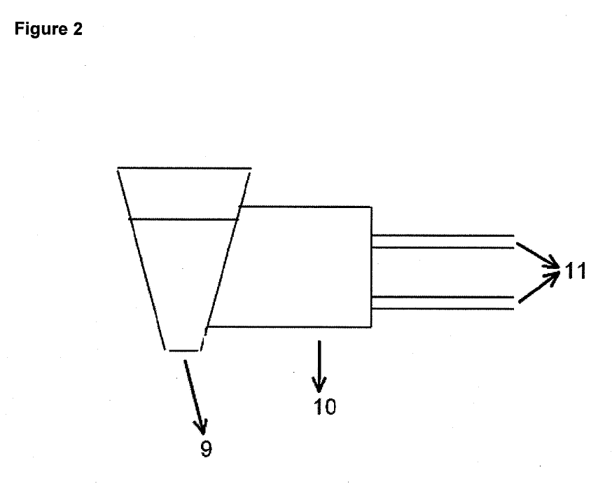

The present invention may be made with any conventional roofing material making apparatus that may be modified to supply fines during the roofing material making process. FIG. 2 shows an exemplary apparatus for applying two strips of fines that may be added to a conventional roofing material making apparatus to make one embodiment of the present invention. A hopper [9] is connected to a granules bin [10], which leads to oscillating level mechanisms [11] for distributing the fines in the desired positions. Insert chutes can be included in the granule bins of an oscillating level mechanism apparatus at the desired position for the fines to be applied. The fines may be applied before, after, or in the blender, or any combination thereof.

### EXAMPLES

### Example 1

Table 1 below shows exemplary roofing materials that were made in accordance with the invention. Each strip of fines deposited on the laminated shingles in the area indicated was about 1 inch wide.

TABLE 1

| | Fines on Dragon | Fines on Shim | Speed (feet per |
|---|---|---|---|
| Sample | Teeth Layer | Layer | minute) |
| Control | — | — | 200 |
| 1 | | X | 200 |
| 2 | X | | 200 |
| 3 | X | X | 200 |
| 4 | X | X | 400 |

Table 2 below includes data showing the physical properties of each of the exemplary roofing materials. The properties provided in Table 2 include the following:
1. Bundle distortion was measured before and after heat soaking a bundle of shingles at 140° F. in a wind tunnel for 24 hours. Measurements of the crown and each corner of the bundle were taken before and after soaking. The difference between the crown height and the average of the comers is provided in Table 2 as the amount of distortion. An average from 5 trials is provided in Table 2.
2. Slump performance was measured by determining the temperature at which the shim slips away from the dragon teeth layer of a vertically hung laminated shingle. Controls are provided from two types of conventional shingles.
3. Wind performance was measured by testing the shingles at 110 mph in a wind tunnel after 16 hours of conditioning at 140° F. (+/−5° F.) and blowing the deck at 75° F. (+/−5° F.) for two hours.
4. Fusing/sticking in the bundle was measured when the bundles of shingles were double-stacked in the wind tunnel and subjected to heat-soaking at 105° F. for 3 days and then cold-soaking at 40° F. for 2 days. The bottom three layers were inspected for fusing/sticking.

TABLE 2

| | | Sam- | Sam- | Sam- | Sam- |
|---|---|---|---|---|---|
| Property | Control | ple 1 | ple 2 | ple 3 | ple 4 |
| Bundle Distortion | 0.72 | 0.73 | 0.63 | 0.42 | 0.50 |
| before heat soak | | | | | |
| Bundle Distortion | 0.81 | 0.89 | 0.61 | 0.42 | 0.55 |
| after heat soak | | | | | |
| Slump | 145° F./ | 137.5° F. | N/A | N/A | N/A |
| Performance | 150.5° F. | | | | |
| Wind | passed | N/A | N/A | passed* | N/A |
| Performance | | | | | |
| Fusing/sticking | none | N/A | none | none | N/A |

N/A—Results not available.
*One batched failed due to improper adhesion, but the other batch tested passed.

The data in Table 2 show that the shingles of the present invention perform better than conventional shingles with respect to bundle distortion both before and after heat soak. In addition, the shingles of the present invention perform similar to or the same as traditional shingles with respect to slump performance, wind performance and fusing and sticking during storage.

### Example 2

Three additional roofing materials (designated as Samples 5-7) were made in accordance with the invention. Each sample had a strip of fines deposited on the headlap of the dragon teeth layer and on the shim layer of laminated shingles. Sample 5 was run at 450 FPM; Sample 6 was run at 450-500 FPM; and Sample 7 was run at 500 FPM.

Physical properties were tested as indicated in Example 1; however, instead of slump performance, a hang test was conducted. The hang test was performed by determining whether the shim would slip away from the dragon teeth layer of a laminated shingle when clamped to a jig at a fixed temperature of 160° F. for two hours (+/−2 min.). Results of the tests are shown in Table 3.

TABLE 3

| Property | Control | Sample 5 | Sample 6 | Sample 7 |
|---|---|---|---|---|
| Bundle Distortion | 0.4 | 0.235 | N/A | 0.25 |
| before heat soak | | | | |
| Bundle Distortion | 0.29/0.38 | N/A | 0.16 | 0.23 |
| after heat soak | | | | |
| Hang Test | passed | passed | N/A | passed |
| Wind Performance | N/A | N/A | passed | N/A |
| Fusing/sticking | Minor at | N/A | none | none |
| | pressure points | | | |

N/A - Results not available.

The data in Table 3 show that the shingles of the present invention perform better than conventional shingles with respect to bundle distortion, both before and after heat soak, and fusing and sticking during storage. In addition, the shingles of the present invention perform similar to traditional shingles with respect to the hang test.

### Example 3

An additional roofing material (Sample 8) was made in accordance with the invention. Sample 8 was run at 500 FPM and had a strip of fines deposited on the headlap of the dragon teeth layer and on the shim layer of the laminated shingle. Physical properties were also tested as indicated in Example 2. Results of the tests are shown in Table 4.

TABLE 4

| Property | Control | Sample 8 |
|---|---|---|
| Bundle Distortion | 0.41 | 0.16 |
| before heat soak | | |
| Bundle Distortion | 0.34 | 0.14 |
| after heat soak | | |
| Hang Test | passed | passed |
| Fusing/sticking | none | none |

N/A - Results not available.

The data in Table 4 show that the shingles of the present invention perform better than conventional shingles with respect to bundle distortion, both before and after heat soak. In addition, the shingles of the present invention perform the same as traditional shingles with respect to the hang test and fusing and sticking during storage.

It should be understood that the above examples are illustrative, and that compositions other than those described above can be used while utilizing the principles underlying the present invention.

What is claimed is:

1. A roofing material comprising fines deposited on an upper surface of the roofing material.

2. The roofing material of claim 1, wherein the fines are deposited on a non-weathering region of the upper surface.

3. The roofing material of claim 1, wherein the fines are deposited as at least one strip on the upper surface.

4. The roofing material of claim 3, wherein the strip is from about 0.5 inches to about 2.5 inches in width and extends the length of the roofing material at a fixed position from one edge of the roofing material to an opposite edge of the roofing material.

5. The roofing material of claim 4, wherein the strip is from about 0.75 inches to about 1.5 inches in width.

6. The roofing material of claim 5, wherein the strip is about 1 inch in width.

7. The roofing material of claim 1, wherein the roofing material is selected from the group consisting of roll roofing, tab shingles, and laminated shingles.

8. The roofing material of claim 7, wherein the roofing material is a laminated shingle and wherein the upper surface comprises a dragon teeth layer and a shim layer.

9. The roofing material of claim 8, wherein the fines are deposited on at least one of the dragon teeth layer or shim layer, or a combination thereof.

10. The roofing material of claim 9, wherein the fines are deposited on a headlap region of the dragon teeth layer.

11. The roofing material of claim 1, wherein the fines are selected from the group consisting of mica flakes, copper slag, coal slag, sand, talc, expanded clay, slate flour, powdered limestone and silica dust.

12. A laminated shingle comprising fines deposited on an upper surface of the shingle, wherein the upper surface comprises a dragon teeth layer and a shim layer, and wherein the fines are deposited on at least one of the dragon teeth layer or the shim layer, or a combination thereof.

13. The laminated shingle of claim 12, wherein the fines are deposited as a strip.

14. The laminated shingle of claim 13, wherein the strip is from about 0.5 inches to about 2.5 inches in width and extends the length of the shingle at a fixed position from one edge of the shingle to an opposite edge of the shingle.

15. The laminated shingle material of claim 14, wherein the strip is from about 0.75 inches to about 1.5 inches in width.

16. The laminated shingle of claim 15, wherein the strip is about 1 inch in width.
